(19) United States
(12) Patent Application Publication
(10) Pub. No.: US 2005/0173213 A1
(43) Pub. Date: Aug. 11, 2005

(54) Multipurpose hydraulic shock absorber for vehicle

(76) Inventor: Vincent Coquet, Bonnac La Cote (FR)

Correspondence Address: CANTOR COLBURN, LLP, 55 GRIFFIN ROAD SOUTH, BLOOMFIELD, CT, 06002, US

(21) Appl. No.: 10/479,709

(22) PCT Filed: Jun. 11, 2002
(86) PCT No.: PCT/FR02/01994

(30) Foreign Application Priority Data
Jun. 12, 2001 (FR) 01.07993

(51) Int. Cl. F16F 9/34

(52) U.S. Cl. 188/322.13

(57) ABSTRACT

The invention concerns a shock absorber wherein all the adjustable means (70, 71) determining compression phase damping are arranged in the head (61) of the reservoir (R) and are externally accessible without disassembling, and those (71) adjusting low-speed compression, comprise a tubular body (75) for preload adjustment by being screwed in the head (61) of the reservoir, and overlapping outside thereof through an external manoeuvring head (75a), and, inside the reservoir, through an active end configured as a seat (82), said tubular body (75): a) communicating with the shock absorber wide cross-section chamber (G), b) being axially traversed by the adjusting screw (70) bearing, at its end inside the reservoir (R), the valve (72) with its spring-type setting means, and c) including, in its part configured as a seat (82) for the valve (72), at least a radial groove (81) forming an outlet channel determining the preload, the passage cross-section of said channel being determined by the distance between the terminal side (82) of the tubular body (75) and the inner side (61a) of the head (61).

The invention relates to a hydraulic shock absorber for a vehicle; specifically, a shock absorber connected to an oleopneumatic tank independent of it.

Based on documents U.S. Pat. No. 4,958,706 and FR-A-2,764,353 there exists a hydraulic shock absorber consisting of a tubular body in which a piston can move, held by a rod at its extremity, and dividing the body into two chambers: a chamber with a large cross section connecting to the tank and a chamber whose cross section is smaller because the rod of the piston passes through it. The shock absorber is connected to spring-equipped means that bring it into an extended position and that, in general, are made up of a helicoidal compression spring arranged around the body of the shock absorber and resting, on one side, on a mount connected to the body and, on the other side, on a mount connected to the exterior end of the rod, which is equipped, as is the body of the shock absorber, with means of attachment onto the vehicle.

The piston rod is tubular and is traversed by radial holes that connect an annular interior and longitudinal channel to the chamber with the smaller cross section. The annular interior channel is located between a widening of the axial cylinder bore of the tubular piston rod and an axial rod for regulating the calibration of a check valve working with the outlet of this tubular rod in the chamber with the larger cross section. This axial valve is closed when the shock absorber is in the compression phase. In the extension phase, it is raised by a value that varies according to the pressure exerted on it by the fluid and that is therefore dependent on the calibration ensured by the spring-equipped means.

The piston is traversed from end to end by longitudinal channels whose outlets into the chamber with the smaller cross section are blocked by a check valve that is open when the shock absorber is the compression phase and closed when it is in the extension phase.

The oleopneumatic tank is separated by a membrane, or a mobile dividing piston, into a chamber containing gas and a chamber containing oil. This hydraulic chamber connects to the pipe coming from the larger-cross-section chamber of the shock absorber by means of at least two channels, one of which is equipped with means controlling the entry of the fluid into the hydraulic chamber and the other of which is equipped with means controlling the exit of the fluid towards the shock absorber.

In known fashion, when the shock absorber is in the compression phase, the surplus oil contained in the larger-cross-section chamber forms a flow that passes in part through the channels of the piston by raising the corresponding check valve and in part into the hydraulic chamber of the tank. The passage of the oil flows through the check valves generates pressure drops and absorbs the relative motion between the piston and the shock absorber which, depending upon how the valves are set, occurs before or after shock absorption is ensured by the shock absorber spring.

In the extension phase, also known as the expansion phase since it results from the expansion of the spring, the surplus oil found in the smaller-cross-section chamber of the shock absorber generates a flow that passes through the annular channel of the piston rod lifts the axial check valve and passes into the larger-cross-section chamber. Simultaneously, the displacement of the piston creates a suction that generates a compensatory flow originating from the tank and traveling into the same chamber.

The shock absorber's operational characteristics depend in part on those of its means of recall, generally a spring, and must be adapted to the vehicle's conditions of use, namely: utility, road, sport, competition, etc.

The spring is characterized by its forward stroke, defined in connection with the travel of the suspension elements and the body's ground clearance, as well as by its stiffness, adapted to conditions of use. As a result, any change in these conditions makes it necessary either to change the spring or to change the operating parameters of the shock absorber by making adjustments, which in most current shock absorbers takes place after disassembly.

Among the motions of the shock absorber, it is a common practice to view low-speed compression as corresponding to the work of the shock absorber when the wheel passes over a series of small bumps or on a road in poor condition, implying a short stroke at high frequency, and high-speed compression as corresponding to the work of the shock absorber when a wheel passes over a large bump, implying a long stroke at lower frequency. Sometimes a medium-speed setting is added.

Adjusting the low speed is very important to the suspension's performance, since it determines the momentum at which the shock absorber initiates an action in relation to the spring. Indeed, depending upon how the vehicle is used, it affects the vehicle's road traction, its comfort level, its body movement, and how power is transmitted to the ground.

For a lightweight vehicle for road use, comfort is given higher priority over controlling body movement and power transmission to the ground, for which the driver always makes a trade-off. In this case, the setting determines the momentum at which the shock absorber initiates an action in relation to its spring which, by its stiffness, supports the suspended mass that increases along with the speed of the vehicle. The displacement amplitude is small.

For sport use, vehicle body movements linked to variations in mass caused by the speed of the vehicle and must be controlled by the low-speed setting for the shock absorber to work lightly in front of the spring by artificially increasing its stiffness. The effect of this is to stabilize the movements of the body and to increase the vehicle's driving precision.

For all-terrain use, setting the lower speeds is also very important for adapting to the ground type. However, power transmission to the ground is given higher priority over road traction and comfort, which become trade-offs.

The medium-speed settings are intended to cause shock absorption as soon as the assembly's displacement conditions approach the spring's resonance start-up conditions.

The high-speed setting intervenes during a rapid displacement of the suspended mass in order to reduce the braking of the hydraulic flow so that the spring absorbs most of the energy, with the shock absorber only intervening in order to change its stiffness.

No known shock absorber includes all of these adjustment means, much less means that can be adjusted without being disassembled. Those that have low-speed settings use small metal strips that can be deformed elastically. These are known as “metal foils” and are stacked one on top of the other, sometimes with reductions in diameter, and constitute elastic means for closing the check valve by blocking the longitudinal holes of the piston and opening upon expansion. These metal foils are combined with an escape circuit that passes through the piston and marks off what is referred to as a “preload.” The disadvantages of these means are well-known and include the need for disassembly in order to adjust them, the formation of turbulent flows that encourage heating of the fluid, lowering of its viscosity, and changing the shock absorption, but they also include a variation in characteristics as the fluid's passage speed increases and the possibility of deterioration due to turn-up of the small strips upon exceeding their limit of elasticity, causing them to assume the form of an inside-out umbrella.

The two documents cited at the outset implement similar means but add, to the tank head and onto the hydraulic circuit coming from the larger-cross-section chamber, a nozzle whose flow area can be adjusted from the outside. As a result, the preload is realized on the piston and it has all of the disadvantages disclosed above, in particular the fact that it can only be adjusted by disassembly, which limits the range of adjustments made possible by the nozzle in the tank head.

Document FR-A-2,764,353 combines means for regulating high speeds and intermediate speeds with low-speed regulation means. The cap of the tank has two vertical channels connecting to the tank and supplied by a pipe coming from the shock absorber. In one of these channels, a screw is mounted that adjusts the high or average speeds and that has, at its end and in the hydraulic tank, a check valve with its recall means locking it onto a seat, with a load that depends upon how tightly the screw is screwed into the cap. The other channel is equipped with a cone-point set screw whose cone-shaped end fits into a seat in order to mark off a nozzle that enables an adjustable leakage flow to pass through towards the hydraulic chamber of the tank. The cone-point set screw means make it possible to adjust the low-speed compression, whereas the other check valve/spring means make it possible to adjust the high-speed compression. For lower speeds, the preload is defined on the piston and the screw for adjusting the leakage flow, arranged after this preload and on the tank, is supplied via the same channel that supplies the valves for adjusting the average and high speeds. In this way, any adjustment of the leak screw changes the pressure and the output of fluid in the common channel and interacts with the conditions for opening the high- and average-speed valves, whose settings must be readjusted. As a result, the shock absorber may operate in an unstable fashion if one is not thoroughly familiar with it.

The purpose of the invention is to provide a versatile shock absorber for a vehicle that has, both for its compression phase and for its expansion phase, a wide range of adjustability and wherein each of its multiple settings does not affect other settings and is operationally stable.

In order to do this, in the versatile shock absorber of the invention, with all of the adjustable means determining the conditions for shock absorption during the compression phase arranged at the tank head and accessible from the outside without disassembly, and with at least those regulating the compression at low speed including a tubular preload adjustment body screwed into the tank head, extending beyond the latter by means of a lift nipple and, inside the tank, by an active end shaped like a seat, this tubular body:
a) connecting to the large-cross-section chamber of the shock absorber,
b) being traversed axially by an adjusting screw, this screw being screwed into its upper part and having, at its end inside the tank, a valve with its spring-equipped calibration means,
c) and including, on the seat-shaped part for the valve, at least one radial groove forming an outlet channel determining the preload, with the channel's flow area being determined, between a zero value and a maximum value, by the distance between, on the one hand, the end face of the tubular body and, on the other hand, the inner face of the tank head.

In this way, the preload value depends on the flow area from one radial groove made in the end of the tubular body forming a seat for the valve and can be adjusted without influencing the operation of the valve, which is independently adjusted.

Preferably, the lamellar valve, which fits into the longitudinal channels made in the piston, is composed of a single lock washer whose inner edge is clamped inside a recess of the piston by the end face of a shouldered ring, which is itself screwed onto an extension of the piston.

Through this arrangement, which is only possible by all of the controls being installed on the tank, the lamellar valve is composed of a spring leaf whose stiffness is defined and that is able to withstand the effects of consecutive overpressures during high-speed operation without changing shape.

In one embodiment, the high-speed compression adjustment means inside the tank head are combined with very high-speed adjustment means and are composed of a tubular body passing through the head and whose outer end is screwed into the latter, whereas its inner end, passing beyond a channel made in the head, has a valve that fits into a seat formed under the head; the conditions at which the valve will open depend, at high speed, upon the calibration of the lock washers arranged around the inner end of the tubular body and between the valve and a nut screwed onto this end, and at very high speeds, these conditions depend upon the calibration of the lock washers arranged around the end inside the tank for an adjusting rod passing through the tubular body and screwed into it; these washers are placed between a nut screwed onto this rod and the inner diametric surface of a bell, with this bell resting on the end of the tubular body and having a skirt surrounding the high-speed calibration means and extending out towards the valve while providing, between its edge and this valve, an amount of play that corresponds to the valve's maximum clearance when operating at high speed.

This assembly therefore makes it possible to have available on the tank cap two compression adjustment means for high and very high speeds which, since they operate in cascade, contribute to the adjustment means by respectively adjusting the preload via the outlet channel for lower speeds and via the valve for average speeds, each of these adjustments being independent and without consequence to the others while adjustments are being made and while the shock absorber is functioning.

All of these adjustments are made from the outside without any disassembly. It is therefore possible to change very quickly the operating conditions of the shock absorbers of a vehicle, e.g., to switch from road use to track use or for use in sports driving, and also to adapt “hot” adjustments (that is, adjustments made following operation of the shock absorbers) in order to take into account variations in hydraulic fluid viscosity.

Advantageously, the piston is monolithic with a tail rod and a tubular funnel protruding into the large-cross-section chamber and whose internal bore ensures the translatory guiding of the axial check valve head that opens during expansion, with the wall of this funnel being traversed, near the piston and the seat for the axial valve, by several radial channels for the fluid to pass through, whereas the valve seat is formed by a tapered axle end made in the piston and able to accommodate the tapered valve head. This axle end is extended into the piston by a cylinder bore that fits into the cylindrical valve rod to form an annular channel for stabilizing the oil flow that passes through during expansion. This channel is supplied by the radial holes made in the corresponding tubular part of the tail piston rod.

The piston, which is monolithic, along with its funnel and tapered tail rod, is freed from any limitation necessary for its connection to the rod, is more resistant, and may include a larger-diameter tail rod resulting in a larger-cross-section annular internal channel and a larger-diameter valve seat, which along with guiding the valve through the funnel and controlling the flow through the rear of the valve encourages the preservation of laminar flow, which is the sole condition for obtaining a stable output without flutter of the valve. This is not the case in current shock absorbers, where the axial valve often operates in turbulent flow and undergoes flutters that interfere with the expansion of the shock absorber.

The monolithic character of the piston also makes it possible to increase the cross section of the channels cooperating with the lamellar valve and to more easily distribute them, thus improving fluid circulation during the compression phase.

In one embodiment, the funnel of the piston fits into a blind cylinder bore made in the piston head and connected to the tank by means of a connecting channel to form a hydraulic stop in order to gradually stop the piston at the end of the compression stroke.

This stop may assume various forms, which will be described in the following description, at which time the shock absorber of the invention will be described with reference to the attached drawing.

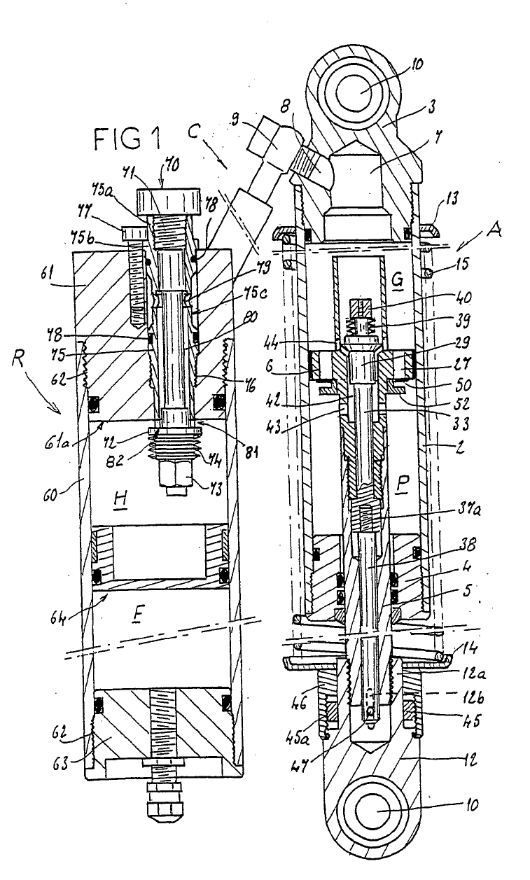

FIG. 1 is a longitudinal cross-section view of the shock absorber with its tank when the piston is in the expansion phase.

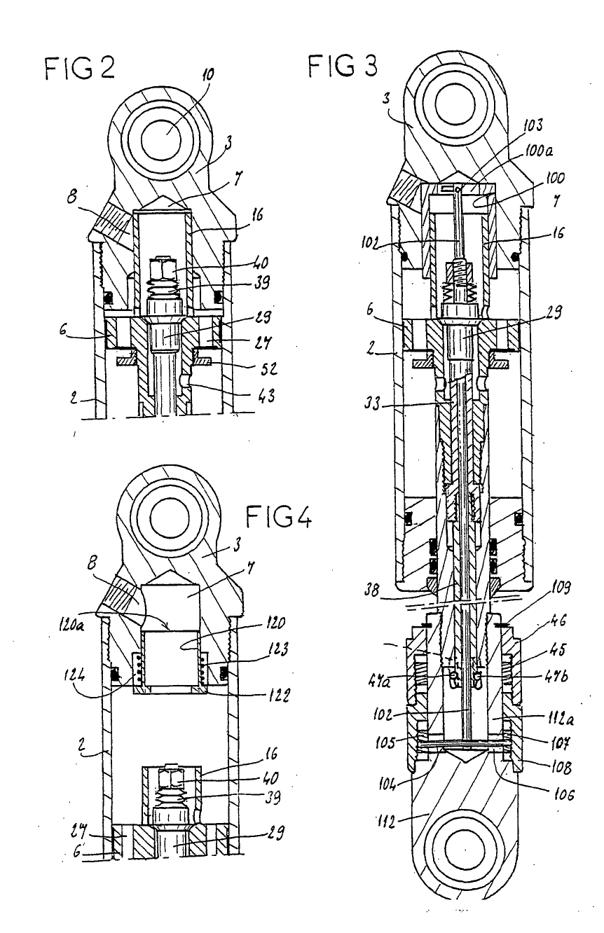

FIG. 2 is a partial view of the head of the shock absorber in FIG. 1 when the piston is at the end of the compression stroke.

FIG. 3 is a longitudinal cross-section view of a shock absorber similar to the one in FIG. 1, but equipped with another embodiment of the hydraulic stop, seen at the end of the compression stroke.

FIG. 4 is a partial view of the head of the shock absorber equipped with another embodiment of the hydraulic stop, seen at the end of the compression stroke.

FIG. 5 is a partial view showing, on an enlarged scale, a variation of the hydraulic stop in FIG. 4 when this stop is at the end of the compression stroke.

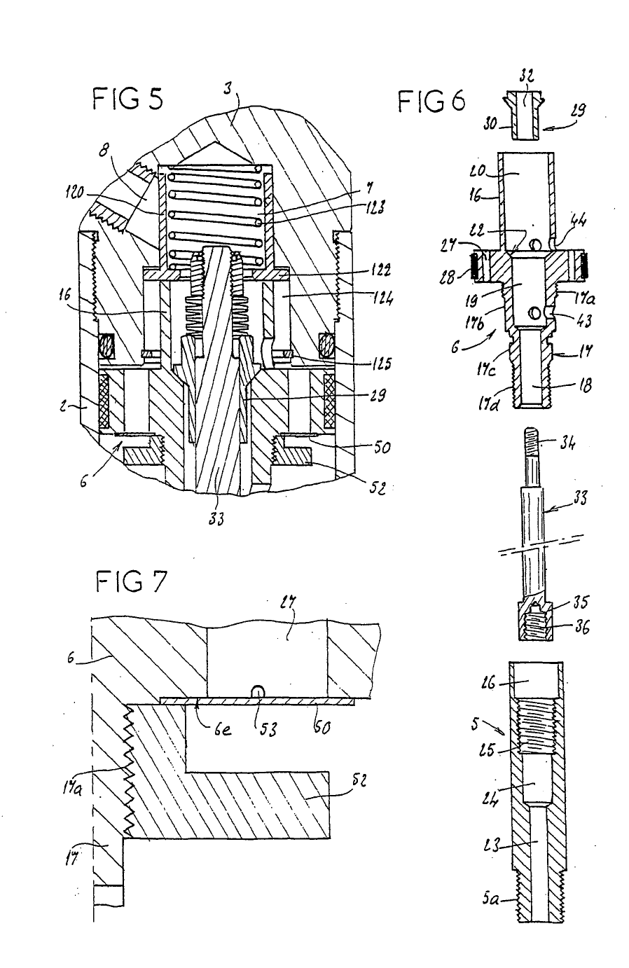

FIG. 6 is a longitudinal cross-section view of the piston and some of the parts associated with it.

FIG. 7 is a partial view, on a very enlarged scale, showing the attachment of the metal ring gear forming a check valve during expansion.

FIG. 8 is a perspective view of the piston.

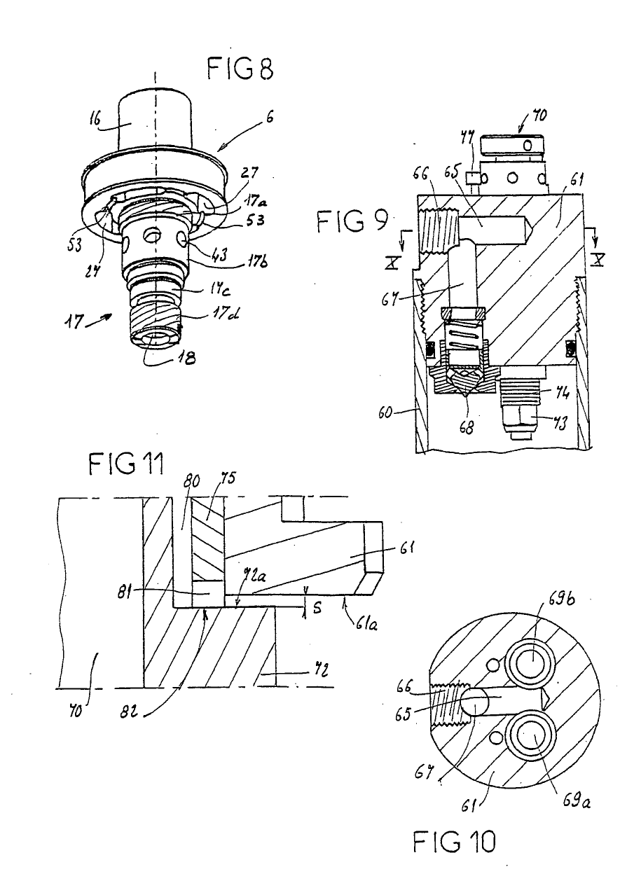

FIG. 9 is a partial longitudinal diametric cross-section view of the tank head.

FIG. 10 is a cross-section view along X-X in FIG. 9.

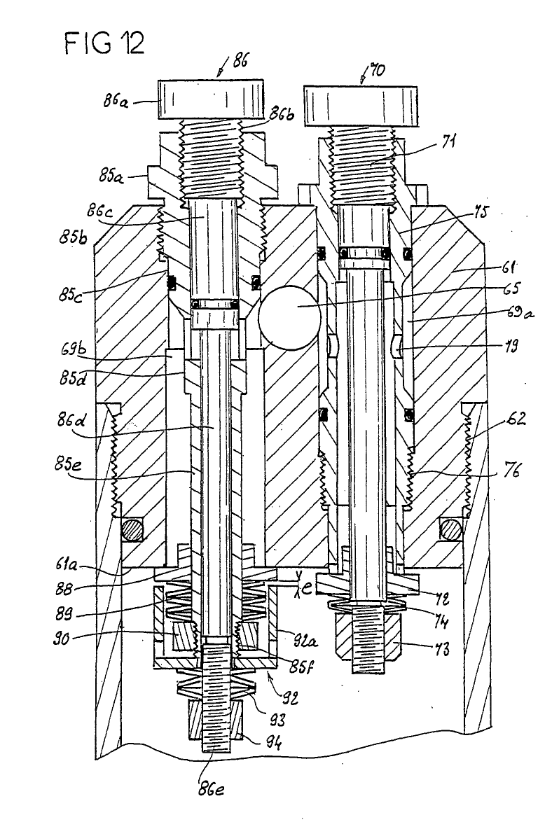

FIG. 11 is a partial view, on a very large scale, showing the means that generate the preload output in the tank head.

FIG. 12 is a cross-section view along XII-XII in FIG. 9, on an enlarged scale, showing an embodiment of this tank head consisting of, in addition to the low-speed and average-speed compression adjustment means, the high-speed and very high-speed adjustment means.

FIGS. 13, 14, and 15 are charts indicating the load of the shock absorber along the y-axis and the compression stroke along the x-axis, and representing the absorption curves obtained by the low, average, high, and very high speed settings, respectively. As seen in FIG. 1, this versatile hydraulic shock absorber is comprised of two parts, namely a shock absorber A and an oleopneumatic tank R. These two elements are connected by a hydraulic pipe C.

The shock absorber A consists of a tubular body 2, one of whose ends is sealed off by the head of the shock absorber 3 and whose other end is blocked by a rod guide 4 that is traversed, axially and in sealed fashion, by means of a tubular rod 5 connected to a piston 6. This piston divides the inner chamber of the shock absorber into a large-cross-section chamber G and a small-cross-section chamber P.

Into chamber G opens a blind cylinder bore 7 made in the head 3 and connecting via a channel 8 to a hydraulic joint 9 screwed into the end of this channel and ensuring the hydraulic connection with pipe C. Head 3 is also equipped with an eye 10 which attaches the shock absorber to the vehicle as does the head 12, screwed into the end of the rod 5. The head 3 of the body and the head 12 of the rod are both integrated into mounts 13 and 14 respectively, on which rest the opposing ends of a helicoidal compression spring 15, which keeps the shock absorber in the extended position.

As is shown in greater detail in FIG. 6, the piston 6 is monolithic with, on the one hand, a funnel 16 and, on the other hand, a tubular tail piston rod 17. Starting from the piston and heading towards the end of the tail piston rod 17, the latter consists of, on the outside and successively, a threaded part 17a, a smaller-diameter cylindrical part 17b, a part having an even smaller diameter 17c, and finally, a smallest-diameter threaded part 17d. On the inside, the tail piston rod 17 is traversed, heading from its interior end towards the piston 6, by an axial cylinder bore 18, by a larger-diameter axial cylinder bore 19, and whose transition with a cylinder bore 20 is made in the funnel 16 and ensured by a tapered seat 22.

The rod 5, which is cylindrical along its entire length on the outside, with the exception of its lower end equipped with a thread 5a that enables its connection to head 12 via screwing, consists on the inside of a series of axial cylinder bores of increasingly large diameters, namely a cylinder bore 23, a cylinder bore 24, a threaded cylinder bore 25, that fits into the threaded end 17d of the piston and a smooth cylinder bore 26, that fits into a smooth cylindrical part 17c of the piston in order to improve the latter's positioning.

The piston 6 is vertically traversed from one end to the other by longitudinal channels 27 that may be circular or that may have an entirely different cross section, as is shown in FIG. 8. At the periphery, the piston 6 is equipped with a groove for trim 28.

The cylinder bore 20 of the funnel 16 has an internal diameter that corresponds roughly, except for the oil clearance, to the outer diameter of a valve 29, which is tapered and extended towards a tail rod 30, whose length is greater than the value of its diameter. This valve consists of an axial cylinder bore 32 through which passes the axial rod 33. The upper end of the axial rod 33 is equipped with a thread 34 and its lower end is equipped with a support head 35, consisting of an axial internal screw thread 36 enabling its connection to the threaded end 37a of control rod 38, as seen in FIG. 1.

When these various elements are assembled as shown in FIG. 1, Belleville-type lock washers 39 rest on the valve 29 and also rest on a nut 40 screwed into the threaded end 34 of the rod 33. This rod fits into the cylinder bore 32 of the valve and marks off, together with cylinder bore 19 of the piston tail rod 17, an annular channel 42. This channel connects to the small-cross-section chamber P by means of radial drillings 43 made in the piston tail rod. By means of its upper part, it forms a smaller-cross-section annular channel around the rod of the valve 30 that helps to stabilize the flow of oil going from the small-cross-section chamber P to the large-cross-section chamber G. This flow passes through the radial holes 43, the channel 42, and between the valve 29 and its seat 22. It then enters the chamber G by passing through the funnel 16 through radial holes 44, which are cylindrical and near tangent to the face of the piston 6 that is turned towards the large-cross-section chamber G.

Adjustment of the calibration of the valve 29, and therefore of the compression of the lock washers 33 by the nut 40, is carried out by using the control rod 38 which, mounted so that it slides inside the cylinder bore 23 of the shock absorber rod 5 goes beyond the end of the latter in order to fit into control means.

In the embodiment shown in FIG. 1, these control means consist of a bushing 45, a threaded thumb wheel 46, and a crossing pin 47. The bushing 45 consists of a smooth cylinder bore by which it is mounted so that it slides on the cylindrical end piece 12a of the head 12. On the outside, it consists of a thread 45a that fits into the internal thread of the thumb wheel 46, mounted so that it rotates on the end piece 12a but oriented translationally in relation to this end piece by a retainer ring (not shown). Pin 47, which is arranged diametrically at the end of the control rod 38, traverses end piece 12a via lights 12b, seen in FIG. 1, and is connected at both ends to bushing 45, which is thereby oriented so that it rotates with optional vertical translation.

In this way, when the thumb wheel 46 is pivoted in one direction or another, it causes the vertical displacement of the rod 38 and consequently that of the rod 33 to whose upper end are attached the support means 40 for the lock washers 39 which rest on the valve 29, which will be referred to as the “axial valve” in the remainder of the description.

The longitudinal channels 27 made in the piston 6 in order to fit into the reverse-lock lamellar valve that opens when the shock absorber is in the compression phase, are blocked by a single metal lock washer 50 replacing the stack of metal foil washers currently used. This washer, seen on an enlarged scale in FIG. 7, is made of spring steel and extends out radially on both sides of the channels 27 and is clamped on its inner edge in an inside recess 6e of piston 6 by the side at the end of a plating ring 52, screwed onto the threaded part 17a of the tail piston rod 17.

With this kind of assembly, the reverse-lock lamellar valve thus constituted has no option for making adjustments while operating, which sets it apart from state-of-the-art shock absorbers, which is not relevant here since all of the compression adjustments are performed on the tank head, as will be discussed in greater detail below.

At low compression speeds, in order to prevent the washer 50 from sticking to the side 6a of the piston and, as is shown in FIGS. 7 and 8, at least one circular groove 53 leads out of this side that connects the channels 27 to each other and reduces the tendency to stick.

The monolithic characteristic of the piston 6 enables its tail piston rod 17 to have a larger diameter and, with an equal stiffness in relation to a tubular rod of a much smaller outer diameter, to make a larger-cross-section annular channel 42 inside this piston that facilitates transfers of fluid and that keeps these transfers in a laminar state, which has the advantage of not affecting the adjustments of the axial valve and of preventing it from fluttering, thus improving the general operation of the piston in the exhaust phase. In parallel fashion, the position and distribution of the channels 27 through which oil passes in the compression phase are no longer defined based on the dimension of the parts connecting the piston to its rod, and may therefore be arranged and organized based on hydraulic criteria alone. In addition, they are sized so that the sum of their cross section is at least 50% greater than the cross section of the pipe 8 for evacuating hydraulic fluid towards the tank R. This arrangement eliminates the phenomena [sic] of cavitation and encourages a consistent laminar state, reduces heating and noises, and improves fluid flow consistency, and therefore the shock absorber's performance.

Before describing the shock absorber's operation, we will describe its tank R and the adjustment means arranged on this tank.

Like current tanks, the one having the embodiment shown in FIG. 1 is composed of a tubular body 60 equipped with interior threads 62 at each of its ends, threads into which are screwed, respectively, a head 61 and a cap 63. The body 60 consists of a dividing piston 64 that divides it into a chamber F which holds a pressurized gas and a chamber H containing a hydraulic fluid.

FIGS. 9 and 10 show that the head 61 consists of a radial pipe 65 leading to the outside via a larger-diameter threaded cylinder bore 66, that can fit into the threaded tip of joint 9 equipping the other end of the pipe C connecting to the shock absorber. The channel 65 connects to a longitudinal channel 67, at the end of which is mounted a check valve 68 that opens when the shock absorber is in the extension phase in order to encourage the return of the hydraulic fluid into the chamber G. It also connects either to the single vertical cylinder bore 69a when the head 61 only consists of low- and high-speed adjustment means as shown in the embodiment in FIG. 1, or with two channels 69a, 69b, when the head includes low-speed, average-speed, high-speed and very-high-speed adjustment means, as shown in the embodiment in FIG. 12.

FIG. 1, which thus represents the tank equipped with low- and high-speed adjustment means, consists of, in known fashion, an adjustment rod 70 with an upper end equipped with a thread 71 and a lower end arranged in the hydraulic chamber H. The latter acts as a guide for a valve 72 and is equipped with a cylinder bore for a nut 73 determining the calibration of the lock washers 74, resting on the valve. However, unlike existing adjustment means, the valve 72 which here is a flat valve, does not rest against the inner face 61a of the head 61 but instead rests against the end face 82 of a tubular body 75, which is itself screwed by a thread 76 into a threaded part of the cylinder bore 69a of the head. This tubular body 75 goes beyond the head 61 towards the outside through a part 75a, which can be grasped by a tool enabling it to be brought into rotation, and including a shoulder 75b for supporting a lock screw 77. The outer end of the body 75 also includes an inner thread into which is screwed the cylinder bore 71 of the adjustment rod 70. The tubular body 75 consists of a groove 75c which forms, together with the cylinder bore 69a made in the head 61, an annular channel which, insulated by joints 78, connects to the channel 65 and consequently to the large-cross-section chamber G of the shock absorber. The bottom of the groove 75c is traversed by several radial holes 79 that enable the hydraulic fluid to enter an annular channel 80 found between a narrowing of the shaft 70 and the internal cylinder bore of the annular body 75.

As is shown on an enlarged scale in FIG. 11, the tubular body 75 consists of, at its end arranged inside the hydraulic chamber H, at least one radial groove 81 that creates, between its end face 82 that forms a seat for the valve and the valve 72, an outlet whose output may be set from a zero value to a maximum value, depending upon the distance S between the active face 72c of the valve 72 and the inner face 61a of the head 61.

With this layout, when the piston 6 is in the compression phase—that is, when it is drawing closer to the head 3 of the shock absorber—part of the hydraulic fluid contained in the large-cross-section chamber G is flushed into the small-cross-section chamber P by passing through openings 27 of the piston 6 thanks to their being cleared by the washer 50 of the valve. The other part of the fluid is transmitted via pipe C to the chamber 80.

If piston 6 is moving at low speed, the outlet constituted by groove 81 is sufficient to let the output pass without opposing the action of the spring over a stroke of varying length depending upon the setting. Indeed, and as is shown in FIG. 13 where C1 is the curve representing the load variation of the spring 15, and C2, C3, and C4 are the absorption curves obtained for road, sport, and track driving, respectively; adjustments of the preload value—and therefore of the outlet's output—make it possible, without changing the stiffness of the spring, to modify the stiffness of the entire shock absorber when desired. The curve C2 shows that, in road use, a large outlet gives priority to the action of the spring, and therefore to comfort, whereas for sport driving a small outlet makes it possible to reach curve C3, where the predominant action of the spring is quickly replaced by the hydraulic shock absorption that is necessary for controlling the movements of the body and to enable more accurate driving on the bearings. Curve C4 shows that, for track driving, the outlet is even smaller so that the hydraulic shock absorption acts as soon as possible and contributes to the spring's action in order to improve ground traction and power transmission.

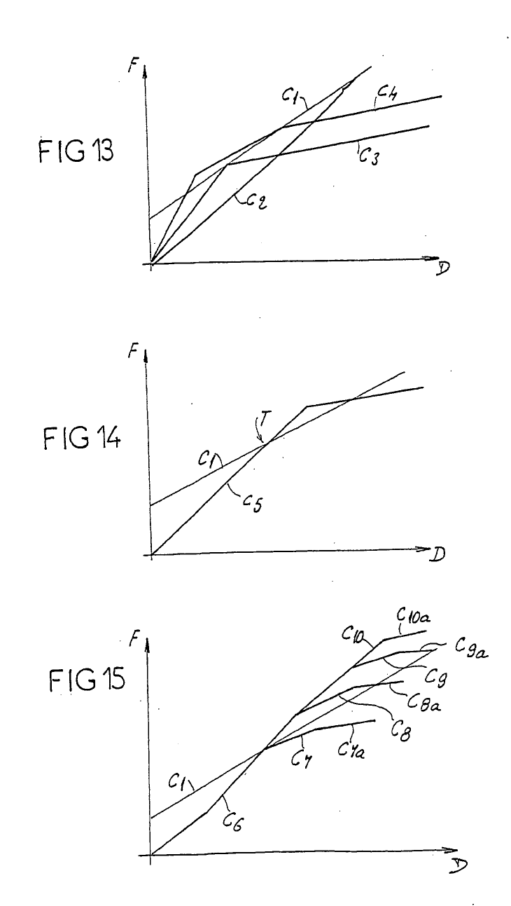

These various use conditions are obtained on the same shock absorber by screwing or unscrewing the tubular body 75 into/from the tank head, in order to change the value S shown in FIG. 11 without influencing the calibration of the valve 72 in any way. The latter opens when the piston's displacement amplitude and speed are close to the conditions at which the spring can become resonant. By means of curve C5, FIG. 14 shows that adjustment via the body 75 makes it possible, if the spring 15 is too flexible, to add hydraulic stiffness eliminating all risk of resonance by means of the shock absorber and starting from any point T of its arrow C1.

It appears that, in comparison to compression adjustment devices utilized in current shock absorbers—devices wherein each compression adjustment for a type of speed affects the adjustment for the other speed(s)—the device of the invention exerts no such influence and in addition makes it possible to adjust the preload at will depending upon ground quality, the type of driving to be performed, and upon the temperature of the hydraulic fluid because, due to all of the adjustment means being installed on the outside on the tank head, it is very easy to readjust these settings after the shock absorber has reached its operating temperature.

The embodiment shown in FIG. 12 relates to a tank head 61 which, in addition to the adjustment means previously described, consists of adjustment means for high and very high speeds in a channel 69b that is parallel to channel 69a. These means consist of a tubular body 85 that is traversed axially and longitudinally by an adjustment rod 86. The tubular body 85 consists, from top to bottom, of a head 85a protruding out past the head 61 of the tank and able to be driven by adjustment-enabling means, a threaded part 85b through which it is screwed into a thread of the body 61, a cylindrical part 85c bearing means for sealing the body 61 to the cylinder bore 69b, a narrowing 85d, and a tubular part with a smaller exterior diameter 85e.

The rod 86 is equipped with an actuation head 86a protruding out of the tank and out of the top of the tubular body 85, a threaded part 86b, by which it is screwed into a threaded cylinder bore of the body 85, a cylindrical part 86c, which is mounted so that it slides inside a cylinder bore of the body 85 and bearing sealing means, another part of much smaller diameter 86d that is mounted so that it slides into a cylinder bore of tubular body 85, and of a threaded end 86e. A flat valve 88 that fits into a seat formed by the inner end face 61a of body 61 is mounted so that it slides onto part 85e of the tubular body 85. This valve 88 is attached to its seat by a stack of lock washers 89 that also rest on a nut 90 screwed onto the threaded end 85f of the tubular body. The stack of washers 89 and the nut 90 are arranged inside the skirt 92a of a bell 92. The diametric wall 92b of the latter is pressed against the end face of the tubular body 85 by a stack of lock washers 93 arranged around the threaded part 86e and whose calibration is determined by a nut 94 screwed onto this threaded part 86e. FIG. 12 shows that under normal adjustment conditions the side of the skirt 92a of the bell 92 is located away from the valve 88 at a distance E.

In this tank head, the screw 70 participates in low-speed compression adjustment, tubular body 75 in average-speed adjustment, tubular body 85 in high-speed adjustment, and axial rod 86 in very-high-speed adjustment. Relative to tubular body 85, it is easily understood that its screwing or unscrewing in relation to the head 61 makes it possible to change the position of the nut 90 in relation to the valve 88, and consequently to change the tightening rate of the elastic washers 89. In regard to the rod 86, its screwing and unscrewing in relation to the body 85 makes it possible to displace the nut 94, to change the tightening of the stack of washers 93 pressing the bell 92 onto the end of the body 85, and therefore the calibration procured by means of these washers.

During operation, for low and average speeds for displacement of the piston 6 in its body 2, shock absorption control is ensured by the valve 72, as was previously explained in reference to FIG. 1.

If the piston 6 is displaced at high speed and generates a high-value pressure wave in chamber G of the shock absorber, shock absorption control is first ensured by the spring 15 as shown in C6 of FIG. 15, then is assisted by a hydraulic shock absorption up to a threshold determined by the opening of the high-speed valve 88 which, by lifting itself out of its seat, frees the channel 69b and allows fluid to enter the chamber H. Curves C7, C8, C9, and C10 of FIG. 15, corresponding to road use, sports use, or all-terrain use, show that this threshold may be adjusted based on specific vehicle use needs.

If the pressure is very high and corresponds to a very-high-speed displacement, for example at a rate of 2.5 meters/second over a 200 mm stroke, the valve 88 makes contact with the skirt 92a and may displace this skirt at the stack of washers 93 by increasing the flow area for the fluid when leaving the channel 69b in order to enter chamber H of the tank; in other words, by reducing the braking effect produced by the valve. In FIG. 15, this change in shock absorption conditions is represented by curves C7a, C8a, C9a, and C10a.

With this arrangement, during the compression phase at high or very high speed, the output of hydraulic fluid occurs with the appropriate areas, under conditions favoring a consistent laminar state, which has the advantage of yielding regular outputs without running the risk of valve flutter and of reducing fluid heating that changes the viscosity of this fluid and makes new adjustments necessary.

Unlike current shock absorbers, and thanks to the ease of adjustment using means 70, 75, 85, and 86, which are accessible from the exterior, as well as to the organization of the valves ensuring consistent operation, it is not necessary to intervene on the lamellar valve 50 arranged on the piston 6 in order to adjust the compression; in this way, the valve's setting can remain consistent.

In order to prevent, especially at very high compression speed, a mechanic stop of the piston 6 on the head 3 of the body of the shock absorber, the funnel 16 that is integral to the piston fits into the blind cylinder bore 7 of the head 3 to form a hydraulic stop at the end of the stroke.

In the embodiment shown in FIGS. 1 and 2, the blind cylinder bore 7 has a diameter that is equal, except for the oil clearance, to the outer diameter of the funnel 16 such that, at the end of the stroke, the funnel gradually blocks the channel 8 until it reaches the total blockage shown in FIG. 2. This type of stop is useful for all-terrain travel, since it prevents major impacts on the mechanical stops of the vehicle when it goes over a bump.

In the embodiment shown in FIG. 3, the funnel 16 is capped by a mount 100 whose outer diameter is equal to, except for oil clearance, the inner diameter of the blind cylinder bore 7. This mount is installed so that it slides onto the funnel and is positioned in relation to the latter by an axial adjustment rod 102 that longitudinally traverses the rod 33 and the control rod 38, arriving at the adjustment means on the lower head 112 of the shock absorber. The upper end of the rod 102 is arranged loosely in an axial cylinder bore 100a of the bushing 100 and is connected to the diametric wall of this bushing by a diametric pin 103. Its lower end is connected via a diametric pin 104 to a bushing 105 that is mounted so that it slides onto the tubular end piece 112a of the head 112. The pin traverses this tubular end piece via lights 106. The bushing 105 is equipped with an outer thread that fits into the thread 107 of a thumb wheel 108 that is mounted so that it rotates freely on the end piece 112a and is oriented translationally in relation to this end piece. The rotation of the thumb wheel 108 causes the longitudinal displacement of bushing 105 on the end piece 112a and consequently the longitudinal displacement of the rod 102 and of the mount 100.

This arrangement makes it necessary to change the means for connecting the hollow rod 38 for controlling the adjustment of valve 29 to its bushing 45. For this purpose, the diametric pin 47, shown in FIG. 1, is replaced by two transversal pins 47a, 47b arranged on either side of the axial rod 102. These two pins traverse the wall of the tubular end piece 112a via two lights 112b. Bushing 45 fits into a thumb wheel 46 that is oriented for longitudinal translation, on one side, by resting on the thumb wheel 108, which is itself resting on the head 112, and on the other side by a retainer ring 109.

In the embodiment shown in FIGS. 4 and 5, the hydraulic stop is comprised of, in addition to the funnel 16 that is much shorter than in earlier embodiments, a bushing 120 that is mounted so that it slides onto the blind cylinder bore 7 between a position wherein its rear edge 120a frees the channel 8 and a position wherein it completely blocks this channel. Bushing 120 is equipped with a front flange ring 122 that, on one side, receives the support of the end piece of the funnel 16 and on the other side, the support of a recall spring 123. In FIG. 4, the spring 123 is arranged around the bushing 120 in a housing 124 made in the head 3 for the front flange ring 122, whereas in FIG. 5 it is arranged inside the bushing and partially inside the blind housing, against whose bottom it comes to rest.

As is shown in detail in FIG. 5, the flange ring 122 moves inside the housing 124, inside which it is kept back by means of a retainer ring 125, against which it stops when it is in a resting position.

Regardless of the embodiment of the hydraulic stop, when the piston 6 arrives at the end of the stroke, the outer face of its funnel 16 of bushing 100 or of bushing 120 gradually blocks the channel 8 by forming a gradual hydraulic stop that prevents the piston from violently coming into contact with the inner face of the shock absorber head 3.

Adjustable hydraulic stops are of particular interest for sports use or for track use, since they make it possible to adjust the high-speed bearings and to prevent the vehicle from rolling over.

The preceding description demonstrates that the versatile, multiple-setting shock absorber of the invention makes it possible to change settings quickly, e.g., in order to switch from road use to sport or track use, thus eliminating the need for roll bars. In all-terrain use, the speed with which settings can be changed makes it possible to adapt the vehicle to the terrain it encounters: muddy, dry, flat, bumpy, very bumpy, requiring jumps, etc.

1. Versatile hydraulic shock absorber for a vehicle, consisting of:
a shock absorber body (2) divided by a piston (6) and a large-cross-section chamber (G) and a small-cross-section chamber (P),
an oleopneumatic tank (R) whose hydraulic chamber (H) connects to the large-cross-section chamber (G) of the shock absorber body,
a mobile assembly comprised of a piston (6) with its tubular rod (5) and having an annular channel (42) connecting with the small-cross-section chamber (P) and ending with the seat (22), fitting into an axial check valve (29), closed during the compression phase, with the piston (6) being traversed by longitudinal channels (27) that are closed in the expansion phase by means of a lamellar check valve (50),
an axial rod (33) arranged in the mobile assembly and whose end (34), protruding into the large-cross-section chamber (G), bears the calibration means (31, 40) of the axial valve (29), whereas the other end protrudes out of the tubular rod (5) in order to fit into the means for adjusting the calibration of the axial valve (29),
a tank head (61) equipped with compression adjustment means, at least for the lower speeds, these means consisting of an adjusting screw (70) whose rod, inside a channel (69a) connecting to the large-cross-section chamber (G), bears, at its end leading into the hydraulic chamber (H) of the tank (R), an adjustable-calibration valve (72) that fits into a seat,
and a helicoidal spring (15) arranged around the body (2) of the shock absorber and resting on mounts (13, 14) that are connected, respectively, to the body (2) and to the end of the piston rod (5),
wherein all of the adjustment means (70, 71) that determine the shock absorption conditions in the compression phase are located in the head (61) of the tank (R) and are accessible from the outside without disassembly, and the ones (71) that regulate low-speed compression, include the tubular body (75) for adjusting the preload that screws into the head (61) of the tank and protrudes out of the latter by a lift nipple (75a) and, inside the tank, by an active end shaped like a seat (82), with this tubular body (75):
a) connecting to the large-cross-section chamber (G) of the shock absorber,
b) being axially traversed by an adjusting screw (70), which screws into its upper part and bears at its end inside the tank (R), the valve (72) with its spring-equipped calibration means,
c) and including, in its part shaped like a seat (82) for the valve (72), at least one radial groove (81) forming an outlet determining the preload, with the flow area of this channel determined between a zero value and a maximum value by the distance (S) between, on the one hand, the end face (82) of the tubular body (75) and, on the other hand, the inner face (61a) of the tank head (61).

2. Versatile hydraulic shock absorber according to claim 1, wherein the lamellar valve (50), which fits into the longitudinal channels (27) in the piston (6), is constituted by a sole lock washer (50) whose inner edge is clamped inside a recess (6e) of the piston (6) by the end face of a shouldered ring (52), which is itself screwed onto an extension (17) of the piston (6).

3. Versatile hydraulic shock absorber according to claim 2, wherein the face (6a) of the piston (6) against which the lamellar valve (50) presses when it is at rest or in the compression phase, includes, in the support zone of the valve (50), at least one circular groove (53) connecting the outlets of the channels (27) traversing the piston, reducing the surface area between the valve (27) and the face (6a) of the piston where pressing and sticking might occur, and forming a cushion of shock absorbing fluid.

4. Versatile hydraulic shock absorber according to claim 1, wherein the high-speed compression adjustment means, inside the head (61) of the tank with the very-high-speed adjustment means, are constituted by a tubular body (85) traversing the head (61) and whose end outside this head is screwed into this head, whereas its inner end, protruding from a channel (69b) in the head bears a valve (88) fits into a seat formed at the end of the channel (69b), with the conditions for opening this valve (88) depending, at high speed, on the calibration of lock washers (89) arranged around the inner end of the tubular body (75) and between the valve (88) and the nut (90) screwed onto this end and, at very high speeds, on the calibration of lock washers (93) arranged around the end below the tank (R) of an adjustment rod (86) that traverses the tubular body (75) and screws into it, with these washers (93) being located between, on the one hand, a nut (94) screwed onto this rod (86) and, on the other hand, the diametric wall (92b) of a bell (92), resting on the end of the tubular body (75) and whose skirt (92a), surrounding the high-speed calibration means, extends out toward the valve (88) while providing, between its edge and this valve, play (E) corresponding to its opening stroke during high-speed operation.

5. Versatile hydraulic shock absorber according to claim 1, wherein the piston (6) is monolithic with a tail piston rod (17) and a tubular funnel (16) protruding into the large-cross-section chamber (G) and whose internal cylinder bore (20) ensures the translatory guiding of the axial check valve head (29) that opens during expansion, with the wall of this funnel (16) being traversed, near the piston (6) and the seat for the axial valve, by several radial channels (44) for the fluid to pass through, whereas the valve seat (29) is formed by a tapered axle end (22) made in the piston (6) and able to accommodate the tapered valve head. This axle end (22) is extended into the piston by a cylinder bore (19) that fits into the cylindrical valve rod (30) of the valve (29) to form an annular channel (42) for stabilizing the oil flow that passes through during expansion. This channel (42) is supplied by the radial holes (43) made in the corresponding tubular part of the tail piston rod (17) of the piston (6).

6. Versatile hydraulic shock absorber according to claim 5, wherein the funnel (16) of the piston fits into a blind cylinder bore (7) made in the head (3) of the shock absorber and connecting to the tank (R) by a connecting channel (8) to form a hydraulic stop that gradually stops the piston (6) at the end of the compression stroke.

7. Versatile hydraulic shock absorber according to claim 6, wherein the blind cylinder bore (7) of the shock absorber head (3) has a diameter that is equal, except for the oil clearance, to the outer diameter of the funnel (16) such that, at the end of the compression phase, the funnel (16), entering into this blind cylinder bore (7), gradually blocks the connection to the tank (R).

8. Versatile hydraulic shock absorber according to claim 6, wherein a blind cylinder bore (6) of the cylinder bore (7) of the head (3) of the shock absorber contains a bushing (120) that is recalled by a spring (123) against a stop (125) such that its rear edge frees the connecting channel (8) with tank (R), this bushing (120) being equipped on its front edge with a flange (122) arranged in the displacement path of the funnel (16) of the piston, in such a way that at the end of the compression phase, the funnel (16) displaces the bushing (120) into the blind cylinder bore (7) by gradually blocking, by its rear edge, the connecting channel (8) with the tank (R).

9. Versatile hydraulic shock absorber according to claim 6, wherein the funnel (16) of the piston (6) is capped by a mount (100) whose outer diameter is equal, except for oil clearance, to the diameter of the blind cylinder bore (7) of the head (3) of the shock absorber, this mount (100) being adjustable by displacement in longitudinal translation in relation to the funnel (16), by means of an axial control rod (102), mounted so that it slides into the rod (33, 38) for adjusting the check valve (29) and connected, by its end that protrudes beyond the end of this screw adjustment rod, to adjustment means (104, 405, 108) that make it possible to change the position at which this mount (100) starts to block the channel (8) connected to the tank (R).

10. Versatile hydraulic shock absorber according to claim 1, wherein the sum of the flow areas of the longitudinal channels (27) traversing the piston (6) is at least 50% greater than the cross section of the outlet channel (8) leading to the tank (R).
